(19) United States
(12) Patent Application Publication
(10) Pub. No.: US 2008/0091491 A1
(43) Pub. Date: Apr. 17, 2008

(54) Method and/or system for flexible data handling

(75) Inventors: John Thorpe, Sunnyvale, CA (US); Constantin Delivanis, Los Altos Hills, CA (US); Swapan Das, Fremont, CA (US); Morgan Cheng, Fremont, CA (US); Chi Yao, Cupertino, CA (US); Alistair Black, Los Gatos, CA (US)

Correspondence Address: RONALD CRAIG FISH, A LAW CORPORATION, PO BOX 820, LOS GATOS, CA, 95032, US

(73) Assignee: BDNA Corporation

(21) Appl. No.: 11/975,146

(22) Filed: Oct. 16, 2007

Related U.S. Application Data
(62) Division of application No. 10/429,270, filed on May 2, 2003.
Application No. 10/429,270 is a continuation-in-part of application No. 10/125,952, filed on Apr. 18, 2002, now Pat. No. 6,988,134.

(51) Int. Cl. G06Q 10/00; G06F 17/40

(52) U.S. Cl. 705/7

(57) ABSTRACT

Methods and/or systems for representing and/or managing and/or querying data in an information system that allows non-programmer users to make additions of and/or modifications to data items while optionally preserving an underlying potentially complex data structure and preserving the ability to perform flexible and powerful queries and relationships in the data.

### CROSS REFERENCE TO RELATED APPLICATIONS

This application claims priority and is a continuation in part of patent application Ser. No. 10/125,952, filed 18 Apr. 2002 and incorporated herein by reference.

### COPYRIGHT NOTICE

Pursuant to 37 C.F.R. 1.71(e), Applicants note that a portion of this disclosure contains material that is subject to copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records, but otherwise reserves all copyright rights whatsoever.

### FIELD OF INVENTION

The present invention relates to a system and/or method of handling data. More specifically, the invention relates to a data handling method and or system allowing flexible association of data elements and additions and/or definitions of data types.

### BACKGROUND OF INVENTION

Data management systems for managing business data are used to store information about assets, tangible resources and/or intangible or conceptual business important entities such as contracts, transactions, etc. For example, a number of commercially available systems enable users to populate databases with information about such things as business assets, resources, transactions, etc., and to query those databases to create reports.

Typically, a data management system's database is defined by a database schema. A database schema is generally understood in the art as the specifications of such things as: what types of values and/or objects can be stored in a database, how database entities are or are allowed to be related, how those values are organized, etc. Generally, a schema is designed by an expert database designer to address storing the details relevant to a specific topic area while maintaining reasonable execution times for typical queries.

Typically, changing a database schema requires an expert database designer. However, changes to a database schema may often be desired as a result of one or more common business events, such as a reorganization or merger, or operational changes, such as hardware or software changes, or transactional changes, such as enabling a different type of business transaction.

It is generally known within the information handling art how to provide a data system infrastructure that users and/or database designers and/or programmers can use to design systems for managing data. Microsoft Access™ for example is one very well-know database design platform that allows users to construct databases from a number of data tables and to perform data functions such as queries, reports, calculations, etc. Microsoft Access™ provides native “wizards” to allow non-programmer end-users to perform certain functions such as table design and/or query and/or report functions.

Object-oriented database development platforms do exist that allow a database developer to design data objects or elements in terms of types, attributes, objects, families, relationships, etc. Furthermore, a number of general purpose object oriented programming languages exist, such as C++, that allow the specification of types for objects.

While there are a multitude of platforms and methods available for constructing database representations of real-world data, existing platforms are not both flexible and powerful enough for many applications.

### SUMMARY OF INVENTION

General Characteristics and Advantages

The present invention in specific embodiments is involved with and enables methods and/or systems for representing and/or managing and/or querying data in an information system. In further embodiments, the invention is involved with and enables methods and/or systems for representing and/or managing and/or querying data in an information system that allows non-programmer users to make additions of and/or modifications to data items while optionally preserving an underlying potentially complex data structure and preserving the ability to perform flexible and powerful queries and relationships in the data. In further embodiments, the invention is involved with and enables methods and/or systems for representing and/or managing and/or querying data in an information system that allows non-programmer users to make additions of and/or modifications to type definitions while optionally preserving an underlying potentially complex data structure and preserving the ability to perform flexible and powerful queries and relationships in the data. In further embodiments, the invention is involved with and enables methods and/or systems for representing and/or managing and/or querying data in an information system that allows non-programmer users to make associations between data items where those associations are not provided for or anticipated by type definitions while optionally preserving and/or further enabling an ability to perform flexible and powerful queries and relationships in the data.

Data Nodes, Data Node Attributes

In further embodiments and in order to provide one or more of the characteristics described above, the invention provides a method and/or system wherein a particular instance of an entity of interest can be represented as a data node, and a data node can have one or more data node attributes. Data node attributes in specific embodiments can include one or more data node rules and/or one or more data node collection rules. According to specific embodiments of the invention, a data node can represent such things as: tangible resources, intangible or conceptual entities, business information, contracts, transactions, responsibilities, people, mixed groupings of any of the preceding, etc. According to specific embodiments of the invention, a data node attribute generally can be understood as a paired entity including an attribute identifier and attribute values and can represent such things as: cost or other financial data values, characteristics of the data node such as last date updated or archived, etc. According to specific embodiments of the present invention, attribute values as discussed herein can also include rules and/or queries.

Types

In further embodiments and in order to provide one or more of the characteristics described above, the invention provides a method and/or system wherein data nodes in a base data environment are generally each of a particular type wherein the type of a data node specifies the attributes available for that data node and can also specify default values or rules related to one or more attributes. In specific embodiments, the type of a data node also specifies the rules and/or types of rules applicable for that data node. Type definitions in specific embodiments may be generally stored in a type data environment or type database. While the invention may be described herein in terms of databases that are strictly typed, indicating that all data nodes are strictly associated with one type, it should be understood that the invention can also be embodied in mixed systems that allow for one or more data nodes that are not typed or that allow for nodes that are of multiple types.

Type Nodes, Type Tree

In further embodiments and in order to provide one or more of the characteristics described above, the invention provides a method and/or system wherein types are each associated with a type node in a hierarchical type tree. A type tree according to specific embodiments of the present invention allows for attributes including rules and default rule values generally to be specified at a more general or most general (or more ancestral or most ancestral) type node in a type tree and to be propagated to some or all descendant type nodes of the node where the rule or attribute is defined. According to specific embodiments of the present invention, defining attributes at more general type nodes in a type tree allows for more powerful and more general querying, grouping, and reporting of a database of data nodes created and/or specified according to type nodes.

Data Trees

In further embodiments and in order to provide one or more of the characteristics described above, the invention provides a method and/or system wherein data nodes may have antecedent and/or decedent relationships with one or more other data nodes in one or more data trees. In specific embodiments, possible and/or required antecedent and/or decedent relationships of a data node are specified by the type of the data node. In further embodiments, antecedent and/or decedent relationships of a data node can be created by a user independently or relatively independently of type definitions; these relationships are at times herein referred to as container relationships.

User Interface

In further embodiments and in order to provide one or more of the characteristics described above, the invention provides a method and/or system involving one or more user interfaces for performing one or more of the following actions: (1) creating a data node using a type; (2) modifying a data node including modifying data node attributes and/or rules; (3) modifying or adding a type in a type environment; (4) creating a container data tree of data nodes; (5) running one or more queries and/or reports.

Other

Thus, in various embodiments of the invention, a type system is used to correctly populate a database with new data nodes using a selected type node's hierarchical characteristics to create new data nodes. Optionally, type characteristics may be used to propagate other information to new data nodes such as default attribute values and/or business rules. Optionally, type characteristics may be used to initiate the establishment of additional relationships.

Optionally, method and/or systems according to specific embodiments of the present invention may be used to manage data representing a variety of physical resources such as hardware and software resources on a network or abstract resources such as organizations and skill sets. According to a preferred embodiment of the current invention, additional integrated tools may be provided to facilitate activities such as applying a user security model, operating on type definitions and viewing or operating on the data stored in the data management system.

Optionally, a data node data environment may be populated by the automatic discovery of resources on a network. In some cases, the data environment may be queried and/or operated on through a programmatic interface.

Optionally, in further embodiments, a method and/or system according to the invention provides an easy interface for users to modify a database schema by adding or modifying type nodes in a well-defined, hierarchical type node tree. Thus, in specific embodiments, the invention allows users to easily and flexibly extend and/or modify a database schema in powerful ways, while maintaining database integrity and usability even for very large databases.

Optionally, in further embodiments, a method and/or system according to the invention allows a user to group data nodes in flexible ways that are not specified by the type structure of the data environment and require no type structure modification. In specific embodiments, the invention thus allows an end user to make flexible groupings of data nodes and use consistent query features to make queries over new groupings.

Thus various methods for data representation, data handling, data querying, data creating, and data reporting can be employed in specific embodiments. The invention can also be embodied as a computer system and/or program able to provide one or more data handling functions as described herein and/or can optionally be integrated with other components for capturing and/or preparing and/or displaying data such as bar code scanning systems, wireless inventory and/or tracking systems, network management systems, etc.

Various embodiments of the present invention provide methods and/or systems that can be implemented on a general purpose or special purpose information handling system using a suitable programming language such as Java, C++, Cobol, C, Pascal, Fortran, PL1, LISP, assembly, SQL, etc., and any suitable data or formatting specifications, such as HTML, XML, DHTML, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

When used herein, “the invention” should be understood to indicate one or more specific embodiments of the invention. Many variations according to the invention will be understood from the teachings herein to those of skill in the art.

### BRIEF DESCRIPTION OF DRAWINGS

FIG. 1 illustrates a block diagram of a preferred embodiment of the current invention in a network environment.

FIG. 2 illustrates an example of a user interface for adding a new data node to the initial base data tree requiring only the selection of a type according to a preferred embodiment of the current invention.

FIG. 3 illustrates an example of a properties pane for a data node representing a resource according to a preferred embodiment of the current invention.

FIG. 4 illustrates an example of a simple user interface for constructing and executing complex queries of the data tree according to a preferred embodiment of the current invention.

FIG. 5 illustrates an example of a user interface for displaying a node's associations.

FIG. 6A is a block diagram illustrating examples of data node-to-data node relationships.

FIG. 6B is a block diagram illustrating examples of data node-to-data node relationships.

FIGS. 7a, 7b, 7c and 7d illustrate examples of a user interface for creating a new user-defined data node and then establishing data node-to-data node relationships according to a preferred embodiment of the current invention.

FIG. 8 illustrates an example of a user interface for adding a new type node to the type tree requiring only the selection of a parent type for the new type node according to a preferred embodiment of the current invention.

FIGS. 9 and 9A-H illustrates an example of some of the database tables that may be used to instantiate a database for storing data related to the data tree and the type database according to a preferred embodiment of the current invention.

FIG. 10 is a flow diagram of a routine for adding a new node representing a resource to the data tree.

FIG. 11 is a flow diagram of a routine for creating a new type in the type database.

FIG. 12 is a flow diagram of a routine for creating a user defined container data node and establishing node-to-node relationships between one or more existing nodes in the data tree and the new container data node.

### DETAILED DESCRIPTION OF PREFERRED EMBODIMENT

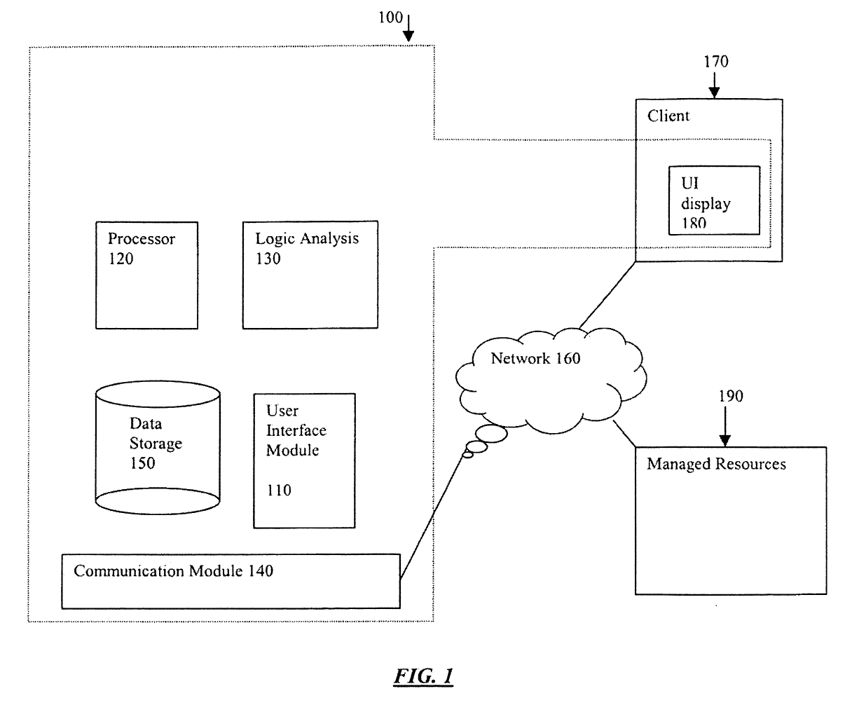

The present invention provides a method and system for managing data representing resources such as abstract and/or concrete assets or business information. FIG. 1 illustrates a block diagram of a preferred embodiment of the current invention in a network environment. A preferred embodiment of the current invention comprises a processor module 120 for manipulating data, a logic analysis module 130 for executing instructions, a data storage module 150 for storing data, a user interface module 110 for displaying output and accepting user input and a communications module 140 to provide a mechanism for communication between modules within the current invention and/or between the current invention and modules and/or devices external to the current invention.

Data Nodes

According to the current invention 100, resources may be represented as nodes such as data nodes in an initial base data environment stored in a data storage module 150. For the purposes of discussion, nodes used for storing data relating to a particular instance of a resource may be referred to as data nodes. For example, when managing an Information Technology (IT) environment on a subnet 180, resources such as servers, software packages, operating systems, routers, graphics cards and network interface cards (NICs) may be represented as data nodes stored in a data storage module 150. Similarly, resources such as abstract resources, intangible assets and/or business information such as memberships, business alliances, contracts, agreements, orders, and invoices may be represented as data nodes in a data storage module 150.

A preferred embodiment of the current invention may be used to manage resources such as tangible resources and/or intangible or conceptual entities. For example, a preferred embodiment of the current invention may be used to provide an environment for managing intangible resources such as providing a resource scheduling environment for keeping track of employees, their skill sets, their location and their availability. Furthermore, a variety of resource management problems may be addressed using a single instance of the current invention. For example, a single instance of the current invention may be used to manage data related to financial and tax concerns as well as tangible asset management, contract management, and human resources.

Data Node Attributes and Data Node Attribute Values

Information related to resources represented as data nodes may be stored in data node attributes as data node attribute values. Preferably, communications module 140 may provide programmatic access to the current invention. Preferably, the initial base data nodes, data node attributes and optional data node attribute values may be populated manually and/or automatically using external modules interfaced with the current invention through the communications module 140. For example, referring to the example of managing an IT environment, a network discovery module may be used to collect information for identifying and characterizing resources. Subsequently, data nodes representing the discovered resources and related data node attributes as well as relationships between data nodes may be created based on that network discovery. Optionally, some data node attribute values may be populated based on information collected using the discovery technique and/or other techniques. Optionally, the initial base data environment may be partially or fully populated through an interface to the communications module 140 with one or more databases, data sources and/or data warehouses external to the current invention. For example, when using the current invention to manage employee work scheduling, data nodes may be created for each active employee based on information collected through an interface with one or more external Human Resources (HR) data warehouses to identify all active employees. Furthermore, employee data nodes may have associated attributes such as office phone number and the attribute values for the office phone number attributes may be populated based on information collected through an interface with a corporate internal phone book database.

Data Node-to-Data Node Relationships and Containers

Preferably, data node-to-data node relationships may be established in the base data environment, automatically by the current invention and/or through a user interface to represent a variety of concepts. For example, in the base data environment, a relationship may be established between a data node representing a personal computer and another data node representing a video card to represent that the video card is installed in the personal computer. In some cases, data node-to-data node relationships can be understood as trees or other groupings in the base data environment that are in addition to and either partly or entirely independent from the primary tree or other relationship structure of the data nodes. In some specific embodiments, these relationships in the data-node environment are referred to as containment relationships; one or more of the related data nodes may be referred to as containers.

According to a preferred embodiment of the current invention, a user may establish one or more relationships through a user interface. For example, a relationship between a data node representing an employee and a data node representing a newly created department may be established to represent that the employee will be a member of the newly created department. For the purposes of discussion, user defined data node-to-data node relationships may be called containment relationships. In some cases, one of the data nodes in a data node-to-data node relationship may be identified as a container. In cases where data nodes may be organized into a hierarchical structure, the parent data node in a containment relationship may be called a container. A container is a data node; preferably, a container is instantiated based on a type. Containers may be used to collect data nodes into groupings for the convenience of the user and/or to support a particular view of the data. For example, a user may choose to create a new data node (or container) called “Contracts I am responsible for” and establish data node-to-data node (or containment) relationships between the new container and existing data nodes representing contracts in the data environment. Preferably, the container may be maintained over time, adding and deleting containment relationships as desired.

Furthermore, in this example, the present invention further allows for data-nodes to be related at the data-node level and in ways that are not specified by types. Containers may provide natural, convenient subsets for constructing queries based on physical, organizational and/or abstract concepts. For example, physical containers may be used for classifying data nodes by physical location descriptions such as cities, buildings, rooms, physical networks and subnets; organizational containers may be used for classifying data nodes by organizational descriptions such as business units (for example, the “Software Support Business Unit”), business functions (for example Finance, Human Resources, etc.) or project names; abstract containers may be used for collecting data nodes representing abstract resources into classifications such as maintenance agreements, purchase orders and contracts.

Type Nodes

According to a preferred embodiment of the current invention, the data nodes representing resources in the initial base data environment and data nodes representing resources added to the base data environment may be instantiated based on a type. Preferably, type information is maintained in a type database and may be stored in data storage module 150. Preferably, information related to a particular type may be represented as a node such as a type node. For the purposes of discussion, nodes used for storing data relating to type are referred to as type nodes. Typically, type information includes a set of one or more attributes that may be associated with a data node. Optionally, type information may include information relating to default attribute values, rules, default rule values and/or relationships. In some cases, rules, default rule values and/or relationship information stored in a type node may be used to automatically create, delete or change data node-to-data node relationships when that type node is used to instantiate a data node.

A rule may be used to store a rule value for maintaining instructions and/or data such as, but not limited to: instructions for calculating a calculated attribute value, instructions for retrieving an attribute value in another database and trigger information identifying the prerequisite conditions for the execution of an automatic action. Examples of automatic actions may include the automatic creation of a new data node or the automatic creation of a data node to data node association. For example, a “Data Center” type may have associated rules and default rule values such as:

| Rule | Default Rule value |
|---|---|
| rule for calculat- | Query for all contained hardware type |
| ing the maximum | data nodes in the Data Center data node, |
| electricity require- | collect the attribute value of maximum |
| ments of a the data | electricity requirement from each |
| center | hardware data node, |
| | sum these values together and |
| | store in the calculated attribute value for the |
| | attribute “maximum electricity requirements |
| | of a the data center” associated with the |
| | Data Center type node. |
| rule for identifying | Query for the facility containing the Data |
| the cost per kilowatt- | Center data, |
| hour of electricity | submit a query to the facilities invoice |
| | system requesting the cost per kilowatt- |
| | hour on the last electricity bill for that |
| | facility. |
| rule for alerting the | Query for all contained uninterruptible |
| systems administrator | power supply (UPS) type data nodes in |
| that it's time to re- | the Data Center data node, |
| evaluate the emergency | for each UPS, count the number of |
| back-up system | supported devices, |
| | for every UPS supporting more than ten |
| | devices or fewer than two, send an alert to |
| | the systems administrator.” |

When a data node is instantiated based on the “Data Center” type node, the rules and default rule values associated with the type are instantiated and associated with the data node.

Preferably, a type database describing one or more types may be present in an initial type database. However, according to a preferred embodiment of the current invention, a user may create, delete and/or alter type information in the type database through a user interface.

Preferably, type nodes may be altered or updated. Preferably, the effect of altering or updating a type node may cascade to data nodes instantiated based on the altered or updated type node. For example, when a type node is altered to add a new attribute, data nodes already instantiated based on the altered type node may be updated to include the new attribute.

Preferably, type nodes may be created by a user through a user interface such as UI display 180 and/or programmatically through an interface such as communications module 140. A new type node may be created to support the representation of a new managed resource.

Type Tree

Preferably, the type data environment or type database represents a tree of type nodes wherein attributes, default attribute values, rules, default rule values and/or relationships may be inherited from one or more ancestors in the type tree. For example, a parent type node used for representing software, a Software type node, may have associated attributes used for representing version and manufacturer. Furthermore, the Software type node may have a child type node used for representing operating systems (the Operating Systems type node) and a grandchild for representing the Linux Operating System (the Linux Operating System type node). According to a preferred embodiment of the current invention, when a new data node of type Linux for representing a specific instance of the Linux operating system on a server is added to the initial base data, the new data node may be populated with the attributes associated with the Linux type node as well as the manufacturer attribute and version attribute inherited from the grandparent type node (the Software type node). Preferably, inheritance may cascade down through all descendent generations of the type tree. Typically, when a data node is instantiated based on a type node in the current system, the type node may be used to correctly populate the data environment. Attributes, attribute values, rules and/or relationships may be automatically associated with the newly created data node based on the type used for instantiation. Preferably, attributes are defined at the highest possible level in the type tree and then inherited down the type tree through all generations. This helps support the construction of queries that will produce consistent results with common meaning across various data nodes.

Furthermore, according to specific embodiments of the present invention attributes may not be redefined at a lower level in the type tree. For example, the version attribute may be associated with the Software type instead of defining it independently and possibly inconsistently at a lower level in the type tree. In this case, querying against the version attribute for all data nodes having a type that is Software or a type that is any direct descendent of the Software type node will have the same, consistent meaning.

Data Tree

Preferably, the data nodes may be organized into a hierarchical tree of data nodes, or a data tree.

Circular References

According to a preferred embodiment of the current invention, a type tree and/or a data tree may be organized in a structure known in the art as an acyclical tree. In an acyclical tree, a node may have none, one or more relationships, however circular references and cycles are not allowed. Preferably, the type tree and the data tree are organized in a type of acyclical tree known as a directed acyclical graph (DAG). In a DAG, a node may have none, one or more children or subnodes as well as none, one or more parents. Circular references and cycles are prohibited in a DAG.

Preferably, circular references and cycles are prohibited in the type tree and the data tree to reduce the possibility of inconsistent and/or confusing query results. Preferably, the mechanism for preventing circular references and cycles may be implemented by creating a taxonomy table of rules dictating allowed parent node-child node relationships and disallowed parent node-child node relationships for both the data tree and the type tree. Preferably, a type relationship model identifying allowable and prohibited relationships based on the types of the nodes may be established. For example, a relationship between a parent data node of type Operating System and a child data node of type Software may be prohibited in one rule whereas a relationship between a parent data node of type Software and a child data node of type Operating System may be allowed in another rule. However, the rules may be based on one or more criteria. A variety of alternate implementations for preventing circular references are possible. For example, testing each potential new relationship by examining the data tree and the type tree before the new relationship is established to confirm that no circular references would be created by the addition of the new relationship may prevent circular references.

Attribute Inheritance in the Type Database

Preferably, inheritance of attributes, attribute values, rules, default rule values and/or relationships may cascade down through all generations of the type tree through parent-child relationships. However, alternate embodiments of the current invention may support different or more complex inheritance models. For example, in some cases, inheritance may not be supported. Alternately, complicated models supporting various degrees of inheritance may be implemented. For example, in some cases, inheritance may cascade down through a limited number of generations for some or all of the type tree. Optionally, in this case, the number of generations for cascading may be determined on a node-by-node basis. Alternately, the number of generations for cascading may be based on one or more criteria, such as by type attribute, default attribute value, rule, default rule value and/or relationship. Preferably, a type node may have a single parent. However, according to alternate embodiments of the current invention, a type node may have more than one parent. In this case, a type node with multiple immediate parents may inherit attributes, default attribute values, rules and/or relationships from one or more ancestors of some or all parents.

However, according to various embodiments of the current invention, none, some or all of the data nodes in the base data environment may be typed. According to various embodiments of the current invention, not all data nodes added to the data tree are required to be typed. However, according to a preferred embodiment of the current invention, strong typing helps preserve the ability to rapidly query the data environment based on any combination of attributes from the data nodes in the initial data environment and any added data nodes without requiring schema changes through operations such as adding and deleting data nodes and adding, deleting and changing data node attributes, data node attribute values, and node-to-node relationships.

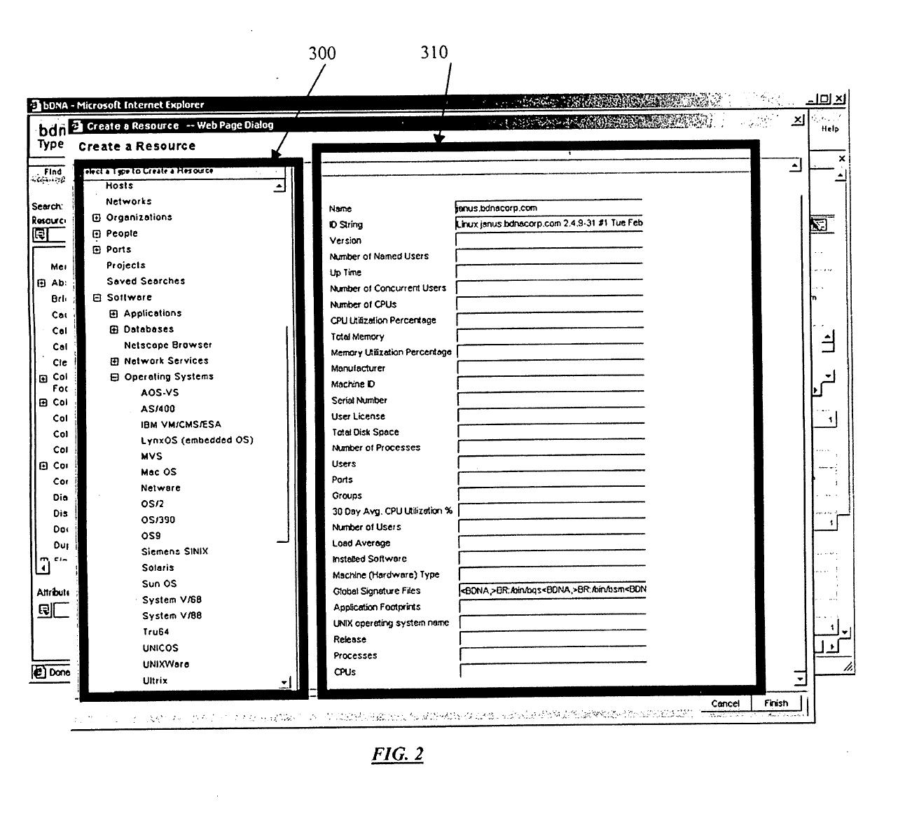

According to the current invention, a new data node may be added to the initial data environment through a simple user interface requiring only the selection of a type for the new data node. FIG. 2 illustrates an example of a user interface for adding a new data node representing a resource to the data environment requiring only the selection of a type according to a preferred embodiment of the current invention. Preferably, the user interface is served by the user interface module 110 through the communication module 140 as a Hypertext Markup Language (HTML) document viewable on a network coupled client 170 using a web browser as the mechanism for producing a UI display 180. However, alternate embodiments of the current invention may present the user interface using other UI technologies such as Simple Object Access Protocol (SOAP). For example, in some cases, the UI display 180 may be directly coupled to the current invention. Furthermore, alternate embodiments of the current invention may be implemented in non-networked environments. In some cases, some or all of the managed resources may not be accessible by the current invention through a network. For example, the current invention may be used to manage non-networked assets such as stand-by equipment. In some cases, some or all of the managed resources may be intermittently accessible by the current invention through a network. For example, the current invention may be used to manage assets such as cell phones, laptops, handheld and/or mobile computers. In this figure, the particular interface shown uses the word “resource” to indicate a data node in a particular application, such as a IT management data application. Thus, the heading “create a resource” is displayed to a user, which can be understood as an example of creating a data node.

In FIG. 2, when adding a new data node, a list of types may be provided to the user in a scrollable window 300 for selection. In this example, an “AS/400” type has been selected by highlighting, resulting in the addition of a new data node to the data environment. Window 310 illustrates a list of the new data node's data node attributes and data node attribute values. In this example, some data node attributes, such as name and ID String have been pre-populated with data node attribute values by the system, whereas other data node attributes, such as version and serial number have not been pre-populated. In this example, the type list in window 310 is nested, reflecting the hierarchy of types in the type tree. In this example, the AS/400 type is a child of the Operating System type and a grandchild of the Software type. In this example, the following type attributes are inherited by the AS/400 type from the grandparent Software type: name, ID string, version, number of named users, number of concurrent users and manufacturer. When the new data node representing the new AS/400 type is created, these type attributes are instantiated into data node attributes and associated with the new data node. According to the current invention, queries of the data tree will reflect the addition of the new node. Optionally, according to a preferred embodiment of the current invention, the attributes displayed in pane 310 may be populated with attribute values by the user at the time of node creation and/or at a later time.

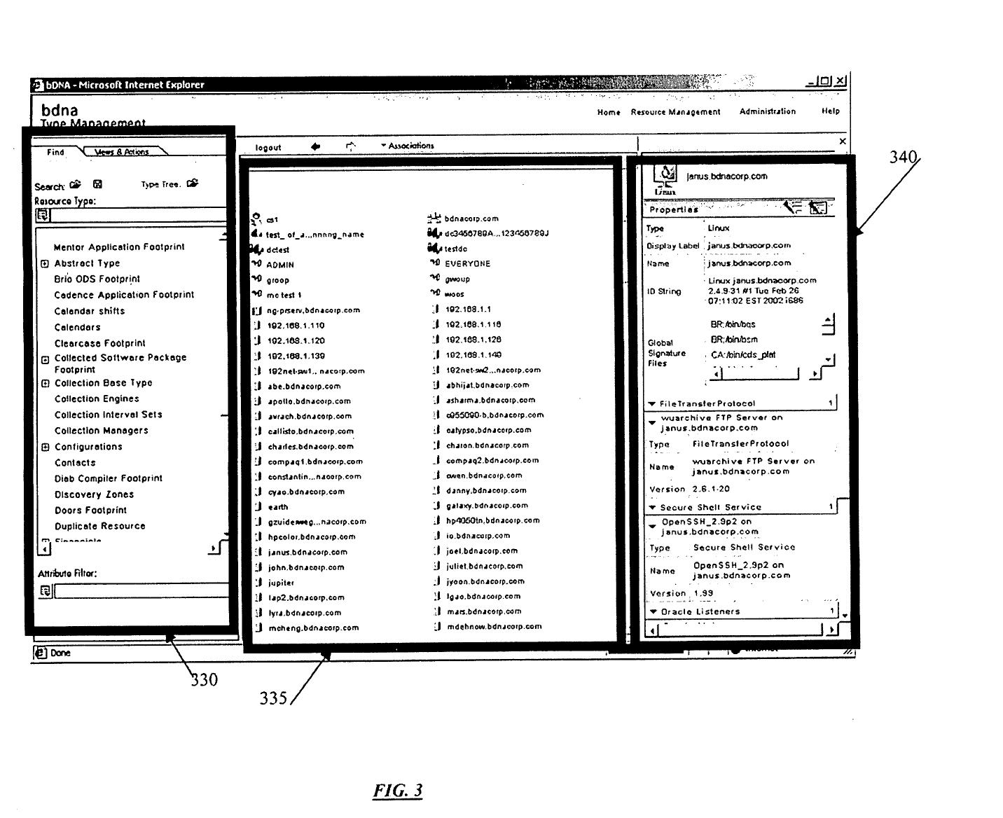

FIG. 3 illustrates an example of a properties pane 340 for a data node representing a resource according to a preferred embodiment of the current invention. According to a preferred embodiment of the current invention, a properties pane may enable the display of various data node attributes and related data node attribute values associated with a particular data node. In this example, a Linux OS data node named “janus.bdnacorp.com” represents an installation of the Linux Operating System. Properties pane 340 displays data node attribute-data node attribute value pairs for this data node such as the data node attribute value “Linux janus.bdnacorp.com 2.4.9-31 #1 Tue Feb. 26 07:11:02 EST 2002 i686” associated with the data node attribute “ID String”. In this example, only some of the data node attribute-data node attribute value pairs are displayed. According to a preferred embodiment of the current invention, some data node attribute-data node attribute value pairs may be hidden from the user in this view. For example, some data node attribute-data node attribute value pairs may be hidden to avoid cluttering the screen and the user may be required to navigate through the UI to view more data node attribute-data node attribute value pairs. Furthermore, a security model may be integrated with the current invention to protect sensitive data according to a preferred embodiment of the current invention. In this case, a user's ability to view some data node attribute-data node attribute value pairs may be restricted based on one or more criterion such as a user's profile. In some cases, the current invention may store more than one value per data node attribute for a particular data node. For example, a data node attribute called “manufacturer” may be associated with an AS/400 type node and have a default data node attribute value of “IBM”. When a new data node named “New AS/400” is instantiated based on the AS/400 type node, a data node attribute called “manufacturer” will be associated with the new data node and have a data node attribute value of “IBM”. However, according to a preferred embodiment of the current invention, a user may override the default “IBM” data node attribute value and manually set the “manufacturer” data node attribute value to “International Business Machines”. In some cases, the current invention may be integrated with an automatic discovery module that may determine that the “manufacturer” data node attribute of the “New AS/400” data node should have a data node attribute value of “IBM Corporation”. In this example, three potential data node attribute values have been identified: a default value, an input value and a collected value. According to a preferred embodiment of the current invention, data precedence rules maybe used to determine which data node attribute value should be displayed or provided to internal and/or external modules. For example, a simple precedence rule may indicate that the data node attribute value with the most recent timestamp should be used. Alternately, precedence rules may be configured to determine precedence by source. For example, the precedence rules could instruct the system to weigh a user's input value more heavily than an automatically collected value. According to a preferred embodiment of the current invention, the precedence rules may be managed on a per data node attribute level. However, according to alternate embodiments of the current invention, the scope of a set of precedence rules may be defined at the level of the base data tree, a base data subtree, a collection of data nodes and/or an individual data node. Preferably, similar precedence rules may be used to resolve similar issues with rules and/or relationships.

Referring again to FIG. 3, note that multiple panes may be visible to the user at the same time. For example, a query pane 330 for displaying a subset of the data nodes in the data tree is displayed concurrently with a query results pane 335 and a properties pane 340. According to various embodiments of the current invention, one or more panes may be displayed concurrently. For example, one or more panes such as, but not limited to, a tools pane, a display pane, a properties pane, an associations pane and/or a search pane may be displayed concurrently.

According to an alternate embodiment of the current invention, one or more additional methods for adding a new data node may be incorporated into the system. For example, in some cases, a new data node may be added to the initial base data environment through a programmatic interface. For example, the current invention may be coupled to a network discovery module that may be used to populate the base data with new data nodes as new elements appear on the network. Similarly, a network discovery module may be used to programmatically create, alter and/or delete data node attributes, data node attribute values, node-to-node relationships, rules and/or data nodes according to information gleaned from the network. Automatic discovery is further discussed in above reference patent application Ser. No. 10/125,952, filed 18 Apr. 2002, incorporated herein by reference.

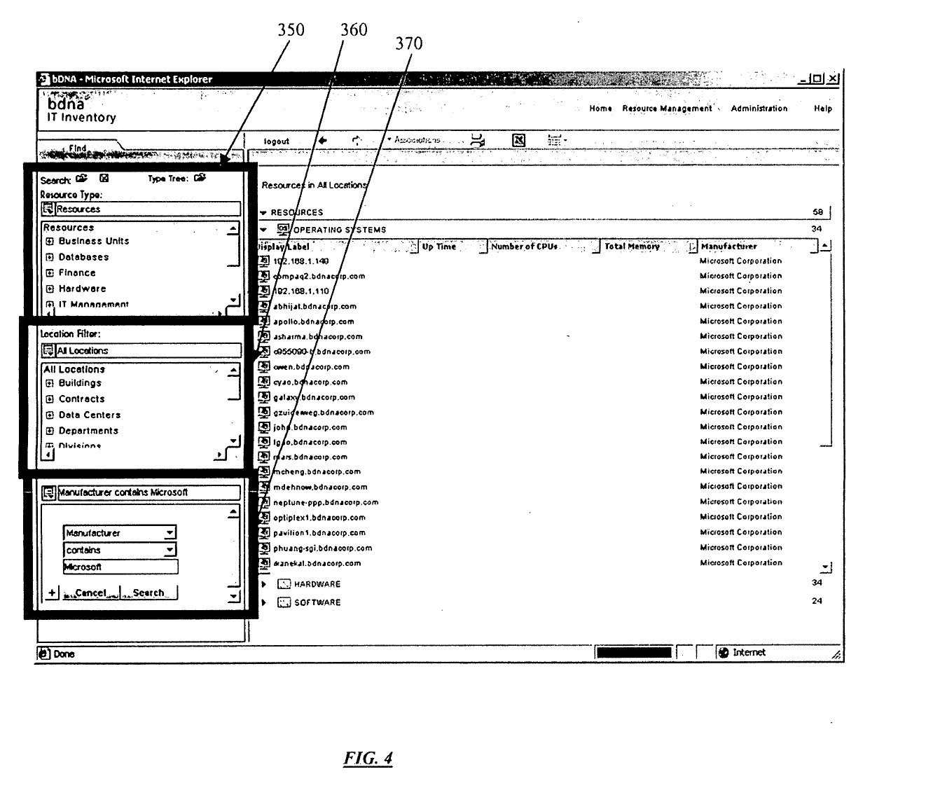

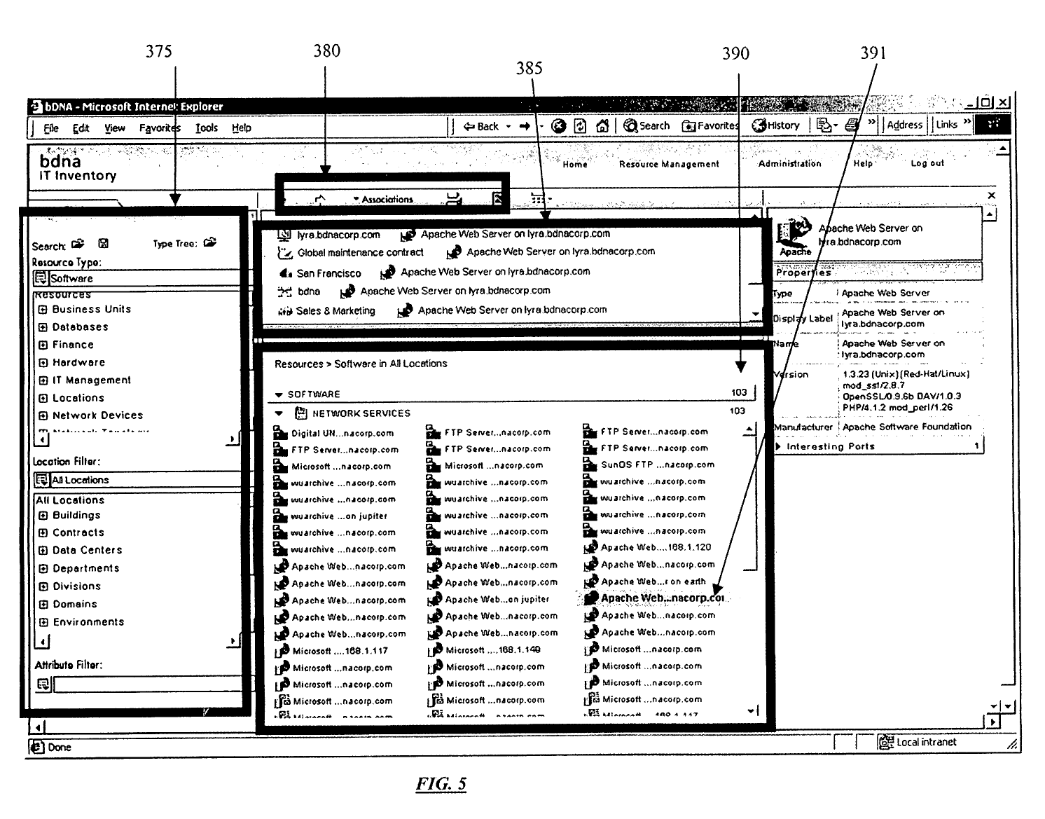

FIG. 4 illustrates an example of a simple user interface for constructing and executing complex queries of the data tree according to a preferred embodiment of the current invention. In this example, pane 350 may be used to narrow down the list of resources by selecting one or more types; pane 360 provides a listing of containers representing locations and may be used to narrow down the list of data nodes by selecting one or more locations; pane may 370 be used to narrow down the list of data nodes by specifying one or more data node attribute-data node attribute value range pairs. In this way, a complex query may be built up using one or more query elements defined in panes 350, 360, and/or 370 and then executed. Preferably, more than one instance of pane 370 may be used to build up complex queries where more than one data node attribute-data node attribute value range pairs may be defined.

FIG. 5 illustrates an example of a simple user interface for displaying the list of containers that contain a particular node. According to a preferred embodiment of the current invention, some or all of the containers related to a particular node may be displayed. In this example, the label “associations” is used to represent a list of containers such as location containers, abstract containers and/or a physical containers as discussed above. In some cases, one or more containers may be excluded from the display list based on one or more criteria such as, but not limited to, the security profile of the user and/or one or more attributes related to the node of interest or the excluded container. Referring to FIG. 5, a query may be constructed in pane 375 to help locate a particular node. The results of the query may be displayed in pane 390. In this example, by highlighting the node of interest 391 and selecting the associations drop down menu 380, a pane 385 may display a listing of container objects that contain node 391.

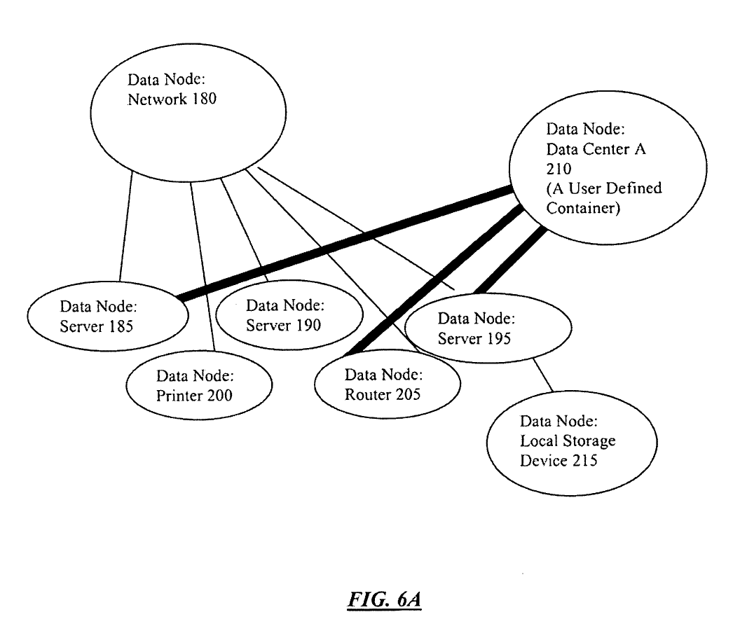

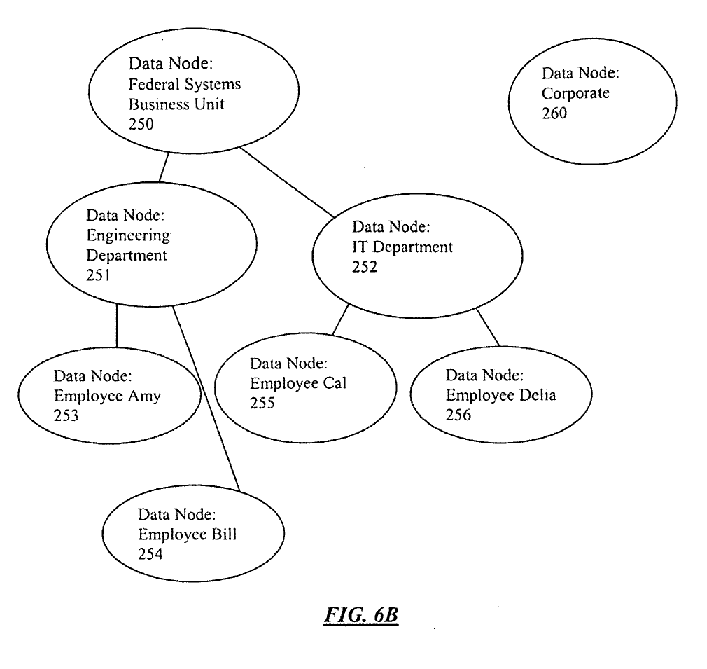

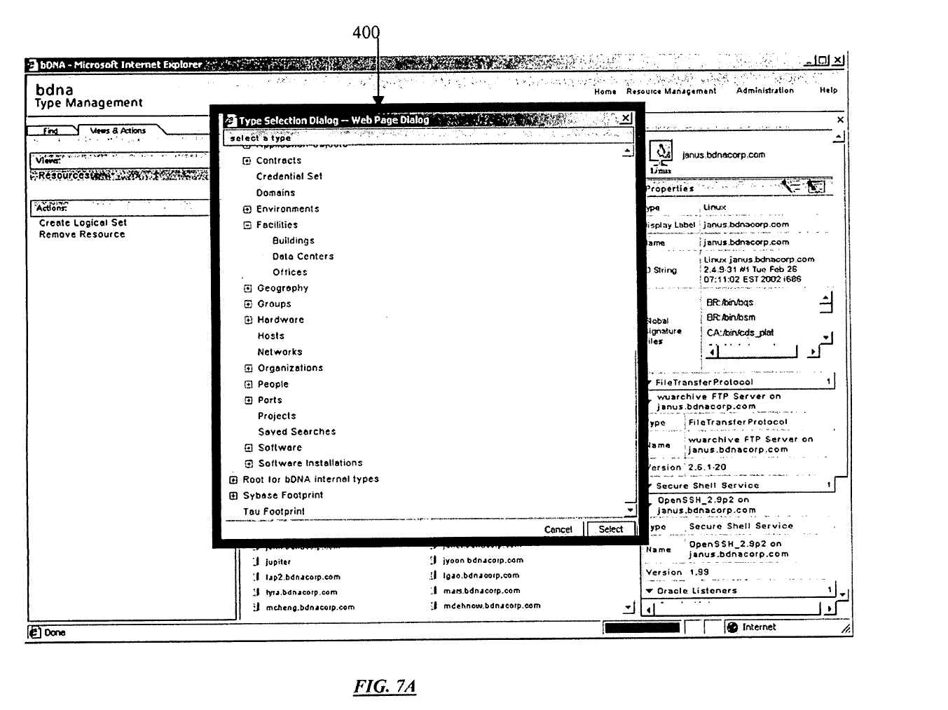

According to a preferred embodiment of the current invention, node-to-node relationships may be created automatically and/or manually. Node-to-node relationships may represent a variety of concepts. FIG. 6A is a block diagram illustrating examples of data node-to-data node relationships. For example, a data node-to-data node relationship between a network data node 180 and hardware data nodes 185, 190, 195, 200 and 205 may represent the concept that pieces of hardware such as servers 185, 190, 195, printer 200 and router 205 are on a particular network such as network 180. Similarly, the data node-to-data node relationship between server 195 and local storage device 215 may represent the concept that the local storage device 215 is installed on server 195. Furthermore, data node-to-data node relationships, also known as containers or logical sets, may be used to create user-defined groupings. For example, a container (or logical set) may be used to organize data nodes by concrete concepts such as data centers and/or abstract concepts such as business units or ownership. Preferably, when a new user-defined container is established, it will appear in the locations container listing. Establishing a data node-to-data node relationship between a data center data node and a server data node may express the concept that a particular server is contained in a particular data center. Referring again to FIG. 6A, a user-defined data node Data Center A 210, may be created and relationships may be established with data nodes 185, 195 and 205 representing hardware that is physically in Data Center A 210. According to a preferred embodiment of the current invention, relationships may cascade; a query requesting a list of all of the local storage devices contained in Data Center A 210 would reflect the presence of local storage device 215 even though a data node-to-data node relationship between local storage device 215 and Data Center A 210 was not explicitly established because the relationship between Data Center A and server 195 cascades down the relationship between server 195 and local storage device 215 resulting in an implicit relationship whereby Data Center A 210 contains local storage device 215. Preferably, relationships may cascade through all levels of the base data tree. However, according to alternate embodiments of the current invention, relationships may cascade through no levels of the data tree or through a limited number of levels of the data tree. In some cases, the number of levels of relationship cascading may be based on a filter such as by data node attribute, data node attribute value, location, and/or data node type.

FIG. 6B is a block diagram illustrating examples of data node-to-data node relationships. In this example, data nodes 250, 251, 252, 253, 254, 255, 256 and 260 represent employees and organizations in an embodiment of the current invention used for managing a human resources (HR) environment. A business reorganization may move all IT departments from individual business units to a corporate function. To reflect this change of responsibility in the current invention, the relationship between data node 252 (representing the local IT department for the Federal Systems Business Unit) and data node 250 (representing the Federal Systems Business Unit) may be broken and another relationship between data node 252 and data node 260 (representing the Corporate Organization) may be established. In this example, the employees of the local IT department (data nodes 255 and 256) may automatically become descendents of the Corporate data node 260 because the relationship between the Corporate organization (data node 260) and the local IT Department (data node 252) cascades down to the employees (data nodes 255 and 256) creating an implicit relationship.

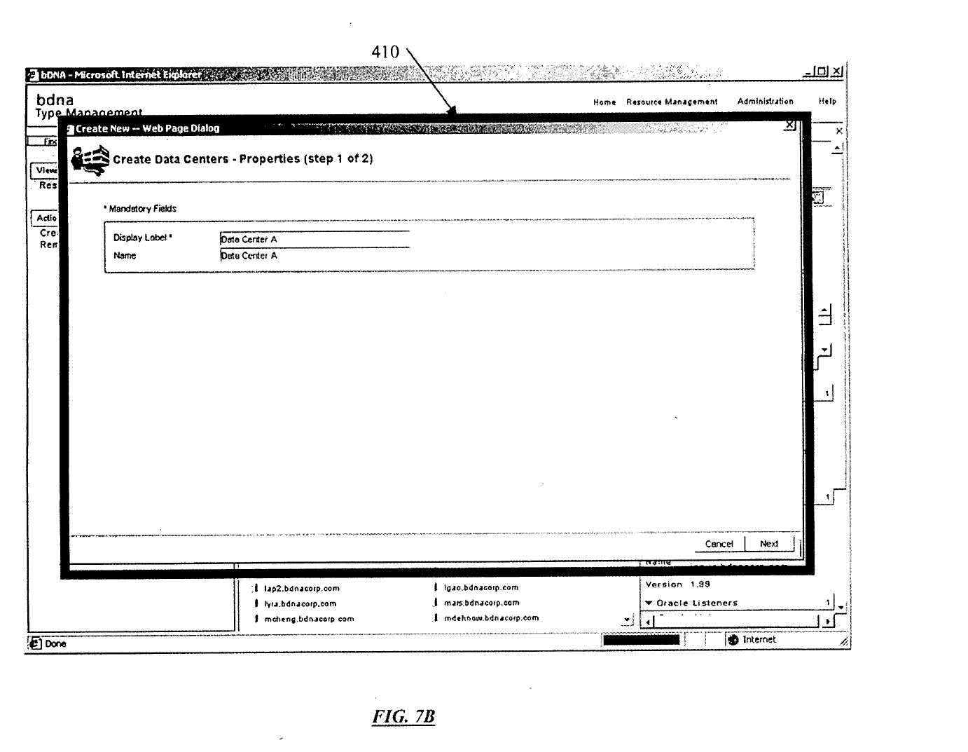

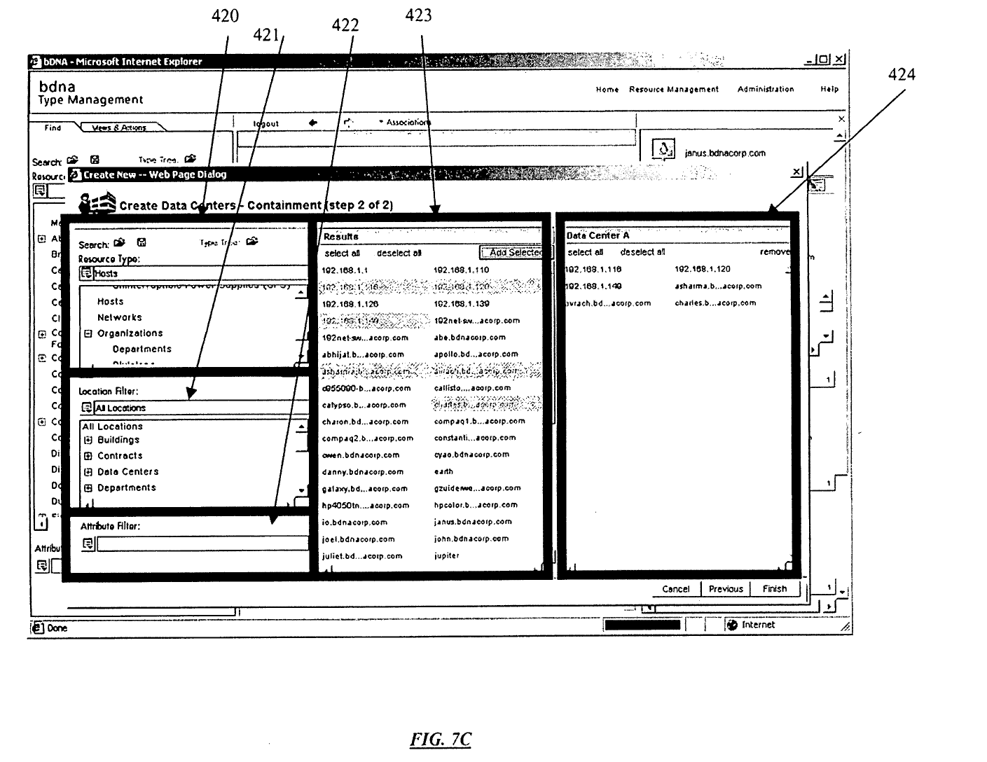

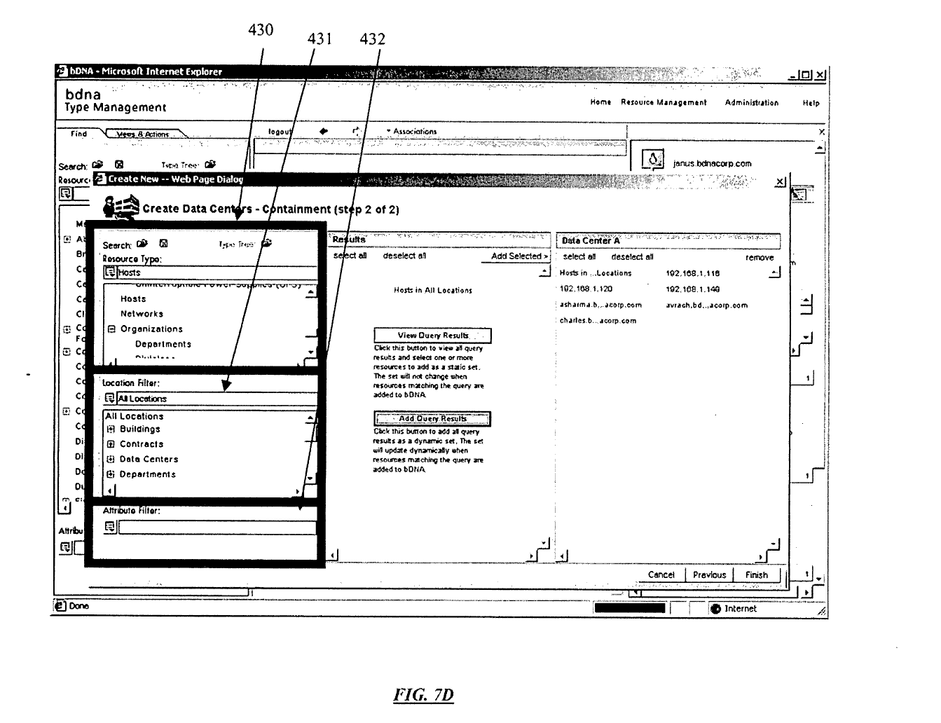

According to a preferred embodiment of the current invention, data node-to-data node relationships (containment relationships) may be established using a simple user interface. FIGS. 7a, 7b, 7c and 7d illustrate examples of a user interface for creating a new user-defined data node and then establishing data node-to-data node relationships according to a preferred embodiment of the current invention. Referring to FIG. 7a, a type for the new data node is selected from window 400. In this example, the user interface uses the label “logical set” to refer to the new user-defined data node. In this example, a logical set is a data node. In this case, the type of the new data node is “Data Center”. In FIG. 7b, window 410 enables the user to input information that may be used to populate data node attribute values for the new data node 210. Now, data node-to-data node relationships may be formed between the new “Data Center A” data node 210 and one or more data nodes in the data tree. According to a preferred embodiment of the current invention, data node-to-data node relationships may be created between the new data node and one or more existing data nodes in the data tree by selecting existing data nodes from a list, as illustrated in FIG. 7c, and/or based on a live query as illustrated in FIG. 7d. Referring to the example illustrated in FIG. 7c, filters 420, 421 and 422 may be used to query the data tree and create a results list of data nodes of interest. The user may then manually select data nodes from the results list 423 to create a list of data nodes 424 to add to the “Data Center A” container. Referring to FIG. 7d, filters 430, 431 and/or 432 may be used to construct dynamic queries that may be used to dynamically and automatically maintain the list of data nodes that may be contained in the “Data Center A” container. This option may be used to dynamically create and/or delete data node-to-data node relationships based on changing data node attribute values thereby automatically maintaining a container without requiring user intervention.

According to a preferred embodiment of the current invention, one or more relationships may be automatically established, altered and/or deleted by the system based on rules maintained inside and/or outside the current invention. For example, a rule for creating and maintaining logical sets representing domains may be established. In this example, a rule may have a rule value providing the following instructions: query the data environment for a list of hostnames, extract domain names from the hostnames, identify a list of unique domain names, locate data nodes corresponding to each unique domain name (or create data nodes corresponding to each unique domain name if required) and establish parent-child relationships between the domain name data nodes and the existing hostname data nodes. Preferably, this rule may be executed due to a user request, other external input and/or initiated by an action such as the addition, deletion or alteration of a hostname data node. According to a preferred embodiment of the current invention, a rule may be scheduled for execution, configured to run at one or more pre-determined intervals and/or triggered by an internal or external action or event such as the addition, change or deletion of a host, hostname or hostname data node.

Adding a New Type

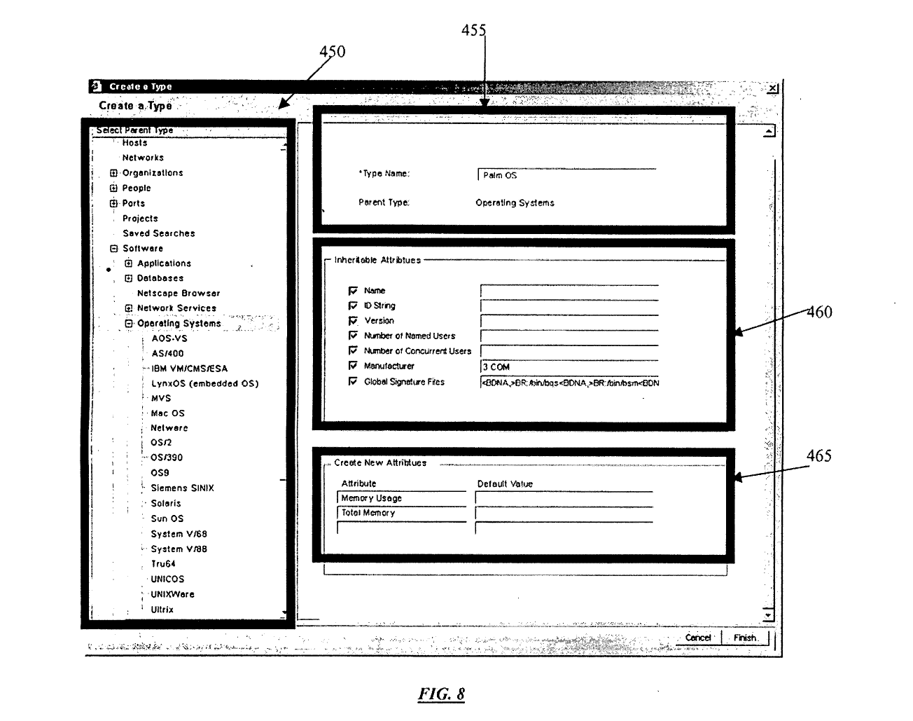

FIG. 8 illustrates an example of a user interface for adding a new type node to the type tree requiring only the selection of a parent type for the new type node according to a preferred embodiment of the current invention. According to a preferred embodiment of the current invention, new type nodes may be created to represent categories for classifying data nodes. Referring to FIG. 8, a new “Palm OS” type may be created to support the categorization of that operating system. In this example, the user is presented with a list of parent types in pane 450 to select as an immediate parent for the new type node. In this example, an “Operating Systems” type node has been selected by highlighting, resulting in the addition of a new type node as a child to the “Operating Systems” type node in the type tree. Optionally, pane 455 provides a mechanism for selecting a name for the new type node. Optionally, a list of the type node attributes and optional type node attribute default values inherited by the new type node may be displayed to the user as illustrated in pane 460. Optionally, the user may be presented with an opportunity to define new type node attributes for the new type node as illustrated in pane 465. In this example, the user is also presented with the opportunity to define new type node default attribute values for the new type node attributes associated with this new type node in pane 465. According to the current invention, new data nodes may be added to the data tree and categorized using the new type. Furthermore, the data tree may be queried based on the new type node and/or any new type node attributes.

According to a preferred embodiment of the current invention, a collection of type nodes may be gathered together into an organizational structure or abstract type structure. In this case, type node-to-type node relationships may be formed wherein an abstract type node is a parent to one or more type nodes and/or abstract type nodes. For example, an abstract type data environment may be used to simplify queries and/or reflect alternate organizational structures. For example, for the purposes of classifying hardware, a network administrator may create a type tree with the following types: servers, printers, fax machines, copiers and routers. However, for the purpose of managing paper supplies, the following types may be collected together into a new abstract type called “Paper Consuming Hardware” to support a view of the type tree for facilities personnel. For example, the “Paper Consuming Hardware” abstract type may be used to represent a collection of the following types: printers, fax machines and copiers. According to a preferred embodiment of the current invention, the abstract type may be used for creating custom displays of the type tree to support a variety of users and purposes. For example, in FIG. 8, pane 450 represents a view of the type tree; pane 450 would be an example of a pane where a custom display of the type tree may appear when abstract types are used. Preferably, the abstract type data environment relationships will support inheritance in the same way that the type tree relationships support inheritance. For example, for a system configured to support inheritance cascading down through all levels of the type tree, if a new type named “Color Printer” is added to the type tree as a child to the “Printer” type, a query of “Paper Consuming Hardware” should reflect all data nodes instantiated with the “Color Printer” type.

Preferably, data storage system 150 may comprise one or more relational databases. In FIG. 1, a single data storage system is illustrated. However, the current invention may comprise one or more data storage systems comprising one or more local and/or remote components such as, but not limited to, one or more remote databases accessible through a network. Furthermore, according to alternate implementations of the current invention, storage system 150 may comprise one or more relational databases and/or alternate data storage and retrieval systems such as, but not limited to, hardware-based data stores, hardware-based databases and a flat file database. Preferably, the data tree and type tree are organized as directed acyclical graphs (DAGs), preventing the establishment of cyclical relationships in the data tree and type tree.

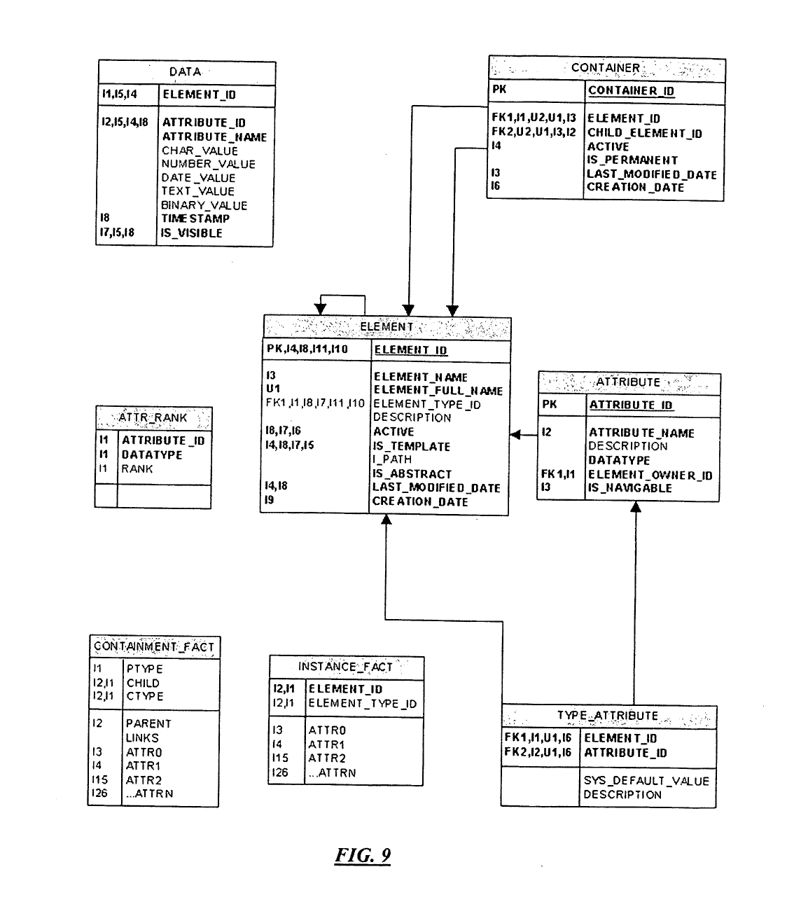

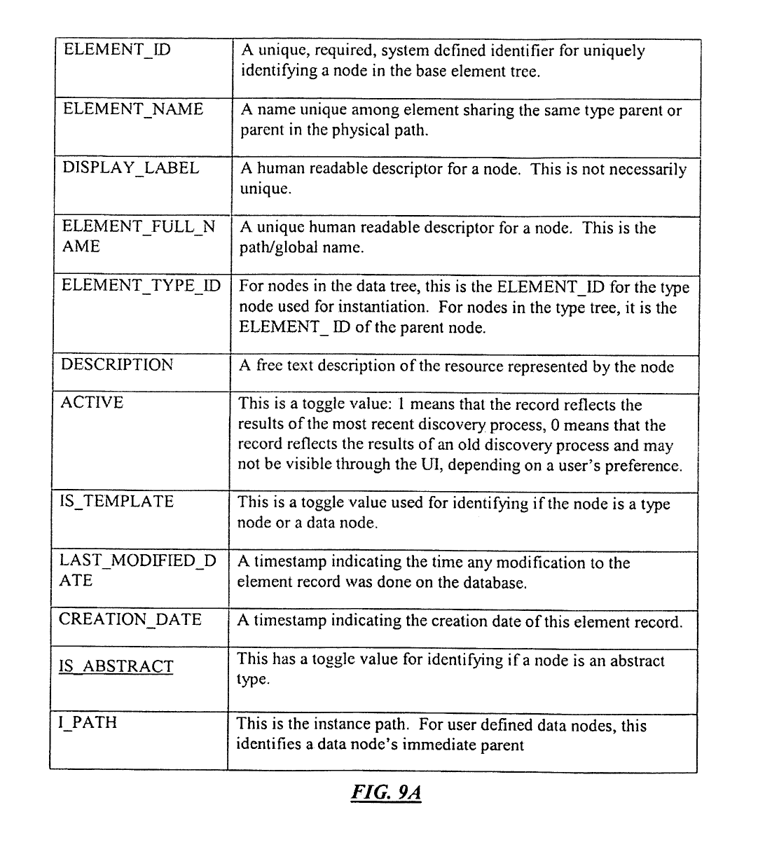

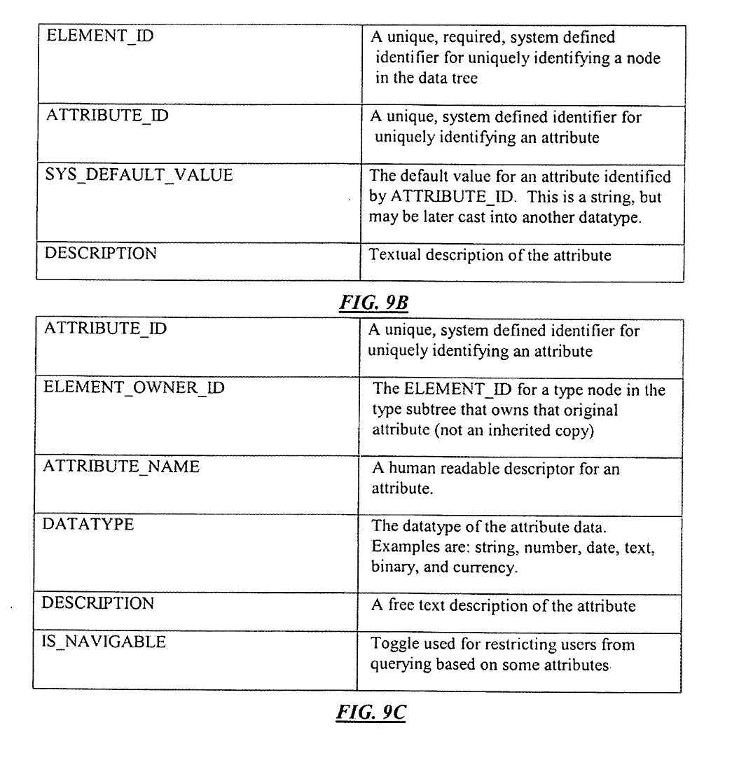

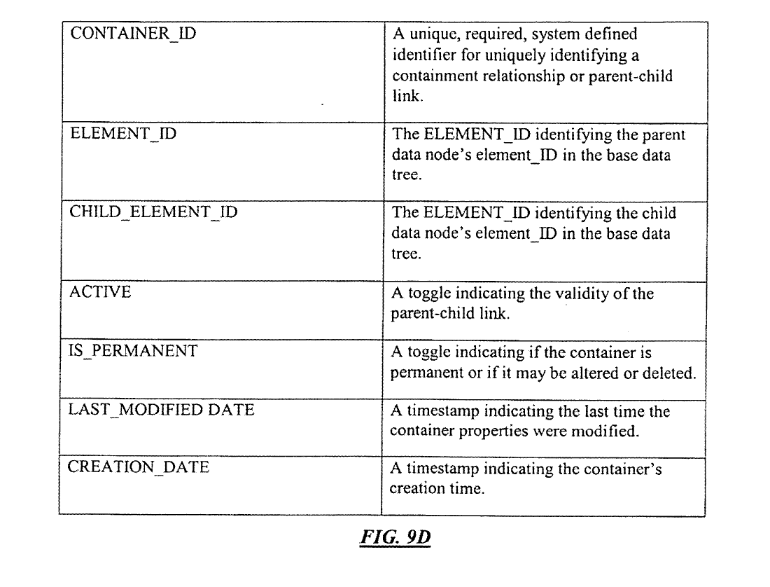

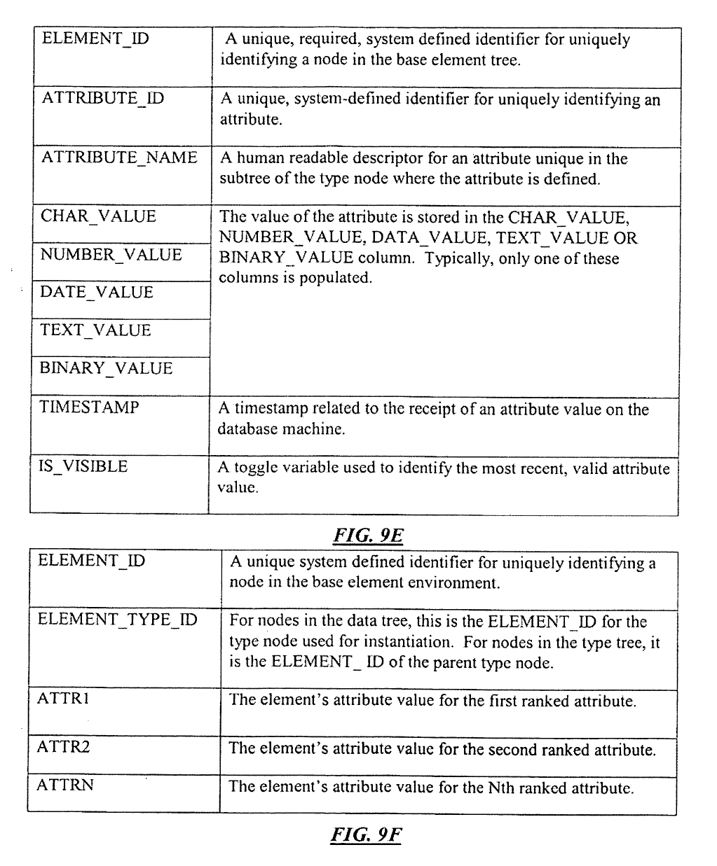

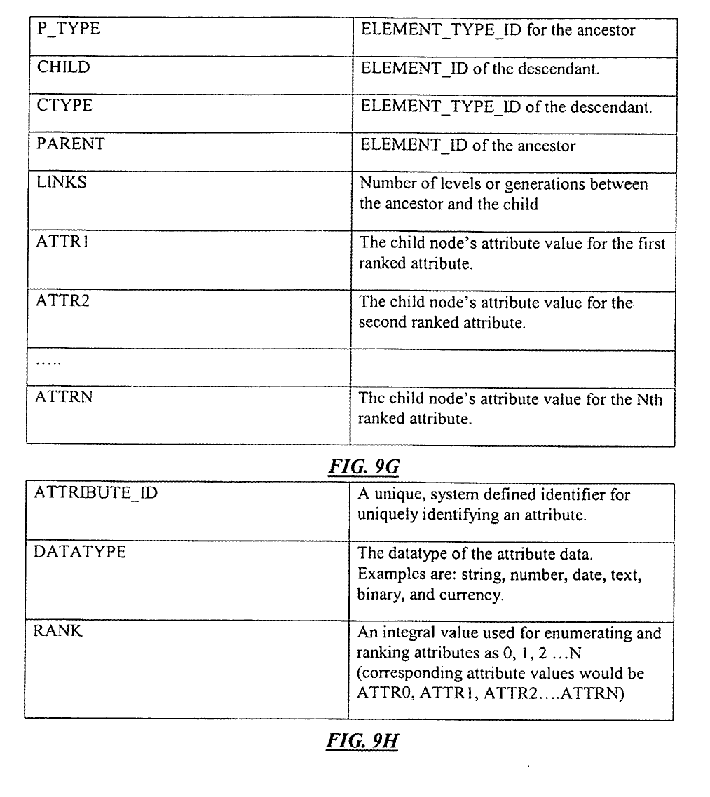

According to a preferred embodiment of the current invention, slow, inconsistent or confusing query results may be minimized by organizing database tables and helper tables in a relational database and maintaining the uniqueness of some labels, identification fields or labels. For example, inconsistent or duplicate identification of a type, type attribute or data node could lead to confusing query results. FIG. 9 illustrates an example of some of the database tables that may be used to instantiate a database for storing data related to the data tree and the type database according to a preferred embodiment of the current invention. Referring to FIG. 9, data related to the initial base tree and the type database may be stored in a relational database comprising the following tables and helper tables: an ELEMENT table, an ATTRIBUTE table, a TYPE_ATTRIBUTE table, a CONTAINER table, a DATA table, an INSTANCE_FACT helper table, a CONTAINMENT_FACT helper table, and an ATTR_RANK helper table. In this example, the helper tables are constructed and maintained to speed up common queries. According to a preferred embodiment of the current invention, the helper tables may be regenerated and/or updated, in response to a change to the data tree and/or type tree, as a scheduled refresh and/or in response to an internal or external event or action.

FIG. 9A illustrates a listing of columns that may be stored in the ELEMENT table, according to a preferred embodiment of the current invention. Preferably, the ELEMENT table supports one record per node instance including both data nodes and type nodes.

FIG. 9B illustrates a listing of columns that may be stored in the TYPE_ATTRIBUTE table, according to a preferred embodiment of the current invention. Preferably, the TYPE_ATTRIBUTE table has one record per type node-attribute combination.

FIG. 9C illustrates a listing of columns that may be stored in the ATTRIBUTE table, according to a preferred embodiment of the current invention. Preferably, the ATTRIBUTE table has one record per attribute of a type.

FIG. 9D illustrates a listing of columns that may be stored in the CONTAINER table, according to a preferred embodiment of the current invention. Preferably, there is one primary record per each parent-child link in the CONTAINER table, with none, one or more other non-primary records for values collected in the past or by lower precedence means.

FIG. 9E illustrates a listing of columns that may be stored in the DATA table, according to a preferred embodiment of the current invention. Preferably, the DATA table has one record per element_id-attribute-attribute value triplet.

FIG. 9F illustrates a listing of columns that may be stored in the INSTANCE_FACT table, according to a preferred embodiment of the current invention. The INSTANCE_FACT table is a helper table. Preferably, for each resource element, there is one record storing the values of the navigable attributes for that element. In this example, the INSTANCE_FACT table is a flattened table of the attribute values per data node.

FIG. 9G illustrates a listing of columns that may be stored in the CONTAINMENT_FACT table, according to a preferred embodiment of the current invention. The CONTAINMENT_FACT table is a helper table. Preferably, for each ancestor-descendant relationship there is one record storing the descendant's attributes. [0067] FIG. 9H illustrates a listing of columns that may be stored in the ATTR_RANK table, according to a preferred embodiment of the current invention. Preferably, the ATTR_RANK table is used to identify and store the rank for each attribute.

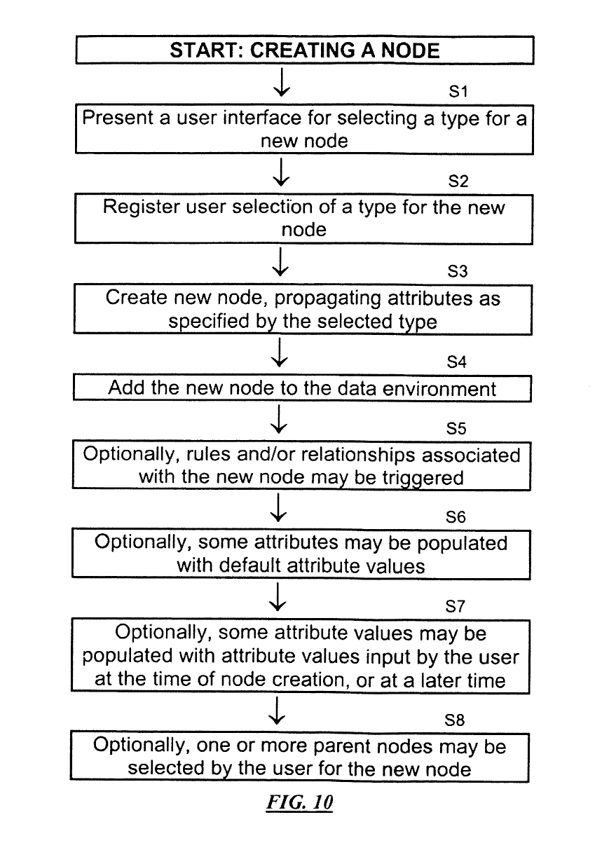

FIG. 10 is a flow diagram of a routine for adding a new node representing a resource to the data tree. The process begins when the system presents the user with a user interface for selecting a type for the new node (S1). Preferably, one or more methods may be used to enable the type selection such as, but not limited to, requesting that the user double click on the desired type name, manually key in a type name using a keyboard, select a type from a drop down list or depress a radio button adjacent to a type name. The user selects a type for the new node through a user interface and the user's selection is registered by the system (S2). The system instantiates a new node representing a resource based on the selected type and properly adds the new node to the data tree, propagating attributes to the new node according to the properties of the selected type (S3). The new node and information associated with the new node is added to the data environment (S4). Optionally, rules, rule values and/or relationships may be associated with the new node and the association of rules, rule values and/or relationships may take place automatically by the system (S5). Alternately, rules, rule values and/or relationships may be associated with the new node by a user through a user interface. Optionally, some attributes may be populated with default attribute values defined by the selected type (S6). Preferably, the type data may be stored in a hierarchical structure such as a type tree and attributes, default attribute values, rules, default rule values and/or relationships may be inherited through one or more generations of the type tree such that inherited attributes may be used when propagating attributes, default attribute values, rules, default rule values and/or relationships to a new node. Preferably, inheritance may extend through all generations of the type tree. Optionally, some attributes may be populated with attribute values input by the user at the time of node creation, or at a later time (S7). As a result, the new data tree supports queries using any combination of attributes from the existing base tree and any new nodes. Preferably, most or all of the nodes in the initial base tree are strongly typed. Optionally, one or more parent nodes may be selected for the new node (S8). Preferably, the data tree may be organized in a data structure such as a directed acyclical graph or unidirectional tree that allows multiple parents and prevents circular references. In this case, the step of establishing a parent-child relationship for the new node may comprise the step of checking for cycles or circular references. Preferably, circular references and cycles may be prevented by creating a taxonomy, table of rules dictating allowed parent node-child node relationships and/or disallowed parent node-child node relationships for both the data tree and the type tree. Preferably, a type relationship model identifying allowable and prohibited relationships based on the types of the nodes may be established.

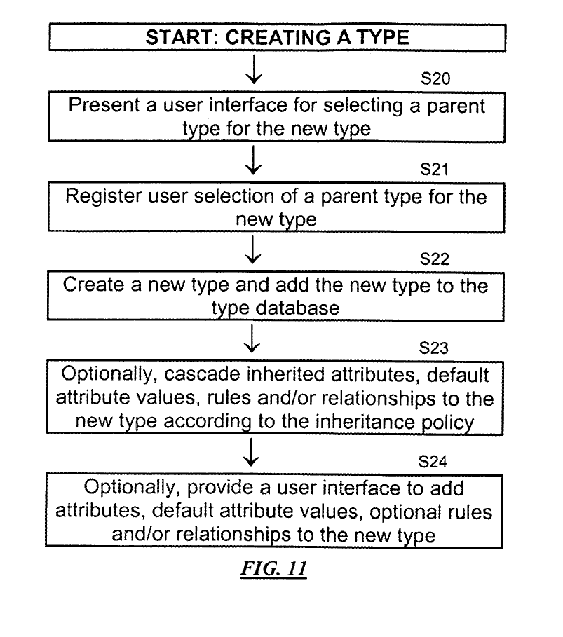

FIG. 11 is a flow diagram of a routine for creating a new type in the type database. The process begins when the system presents the user with a user interface for selecting a parent type for the new type (S20). Preferably, one or more methods may be used to enable the parent type selection such as, but not limited to, requesting that the user double click on the desired parent type name, manually key in a parent type name using a keyboard, select a parent type from a drop down list or depress a radio button adjacent to a parent type name. The user selects a parent type for the new type (S21). The system creates a new type representing a template for the creation of new nodes in the data environment and adds the new type to the type database (S22). Optionally, the system cascades inherited attributes, default attribute values, rules and/or relationships to the new type according to the inheritance policy (S23). Preferably, inheritance may extend through all generations of a type tree. However, a variety of different inheritance policies are possible. Optionally, the user may add attributes, default attribute values, optional rules and/or relationships to the new type (S24). In some cases, existing attributes, default attribute values, optional rules and/or relationships may be added to the new type. Alternately, new attributes, default attribute values, optional rules and/or relationships may be created and added to the new type. As a result, the new type may be used as a template for creating new data nodes that may be populated with attributes, optional default attribute values, optional rules and/or optional relationships in the data tree according to the properties of the new type.

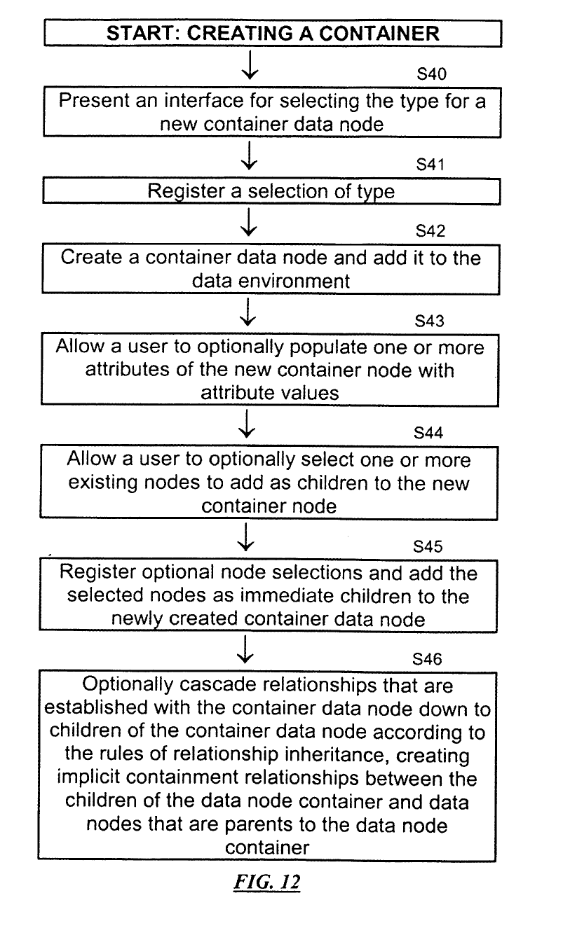

FIG. 12 is a flow diagram of a routine for creating a user defined container data node and establishing node-to-node relationships between one or more existing nodes in the data environment and the new container data node. The process begins when the user is presented with an interface for selecting the type for a new container data node (S40). The user selects a type and the user's selection is registered by the system (S41). The system creates the new container data node and adds it to the data environment (S42). Optionally, the user may populate one or more attributes of the new container node with attribute values (S43). Optionally, the user is presented with an interface for selecting one or more existing nodes to add as children to the new container data node (S44). Preferably, the selection may be done using a simple interface for constructing and executing complex queries on the data tree and/or through a simple interface for navigating the data environment to identify and select data nodes. Optionally, the user can create one or more queries to automatically create and maintain a containment relationship with other data nodes. Optionally, register the user selected nodes from the previous step and add the user selected nodes as immediate children to the newly created container data node (S45). As a result, relationships that are established with the container may now cascade down to the children of the container node according to the rules of relationship inheritance, creating implicit containment relationships between the children of the container and any data nodes that are parents to the container (S46). Similarly, the descendants of the container are descendants of the container's ancestors. Preferably, all relationships cascade down through all levels of the data tree.

The foregoing described embodiments of the invention are provided as illustrations and descriptions. They are not intended to limit the invention to precise form described. In particular, the Applicant contemplates that functional implementation of invention described herein may be implemented equivalently in hardware, software, firmware, or other available functional components or building blocks. Furthermore, the specific discussions of data nodes and type nodes is not meant to preclude the possibility that the current invention may use, manage and/or operate on one or more different varieties of nodes. Other variations and embodiments are possible in light of above teachings, and it is thus intended that the scope of invention not be limited by this Detailed Description, but rather by Claims following.

1-24. (canceled)

24. An information processing system able to manage data associated with business resources and provide custom reports comprising:
a processor for manipulating digital data;
data storage for storing digital data;
a logic analysis component able to execute instructions creating an initial base tree;
a communication module able to communicate with said business resources; and
a set of user interface allowing a user to add typed nodes to said base tree and to query said base tree.

25. The system of claim 24 wherein said set of user interface further comprise:
a plurality of panes;
a plurality of views.

26. The system of claim 24 wherein said set of user interface further comprise:
one or more structured lists allowing a user to add a strongly typed node to said base data environment;

27. An information processing system able to store modifiable information about business resources, said system comprising:
a data store storing information about said resources;
a type data store;
a set of user interface providing options modifying said data store and querying said data store;
wherein said data store comprises:
a plurality of nodes in a tree, a plurality of said nodes having one or more parents and one or more subnodes;
a plurality of resources, a plurality of said resources associated with one or more of said nodes;
wherein a plurality of said nodes can each have associated with it one or more attributes;
wherein an attribute of a node can be set to apply to only that node OR to that node and related nodes at that level OR to that node and all subnodes OR to any combination thereof;
wherein a plurality of said resources can each have associated with it one or more attributes.

28. The information processing system of claim 24 coupled to one or more of:
a network;
an external data source;
a data warehouse; or
a software application.

29. An information processing system for storing information about resources comprising:
means for storing information about said resources;
means for storing type data and/or relationships;
means for allowing users to easily modify and query stored information without changing a schema of said means for storing information;
wherein said means for storing information comprises a plurality of nodes; and
means for associating with a node one or more attributes.
